(19) United States
(12) Patent Application Publication
(10) Pub. No.: US 2011/0018692 A1
(43) Pub. Date: Jan. 27, 2011

(54) Methods and Systems for Validating Code from a Wireless Device

(76) Inventors: Patrick SMITH, San Jose, CA (US); Vivek SUBRAMANIAN, Orinda, CA (US)

Correspondence Address: THE LAW OFFICES OF ANDREW D. FORTNEY, PH.D., P.C., 215 W FALLBROOK AVE SUITE 203, FRESNO, CA, 93711, US

(21) Appl. No.: 12/790,678

(22) Filed: May 28, 2010

Related U.S. Application Data
(60) Provisional application No. 61/182,039, filed on May 28, 2009.

(51) Int. Cl. G06K 7/01

(52) U.S. Cl. 340/10.4

(57) ABSTRACT

Methods, algorithms, architectures, circuits, and/or systems for managing POR-less integrated circuits are disclosed. The method of validating code from a wireless device can include: (i) broadcasting a signal from a reader to the wireless device, (ii) reading a code transmitted, re-radiated, and/or backscattered from the wireless device, the code having a predetermined quality, characteristic, and/or property, (iii) comparing the code to a reference quality, characteristic, and/or property, and (iv) validating the code when the predetermined quality, characteristic, and/or property matches the reference quality, characteristic, and/or property. Embodiments of the present invention can advantageously provide a reliable approach for validating integrated circuits that do not incorporate a POR circuit, and which therefore may transmit spurious bits of data upon being energized. In addition, embodiments of the present invention advantageously allow an Aloha-type anti-collision function to be implemented in a reader based on POR-less integrated circuits.

### RELATED APPLICATIONS

This application claims the benefit of U.S. Provisional Application No. 61/182,039, filed May 5, 2009 (Attorney Docket No. IDR2951), which is incorporated herein by reference in its entirety.

### FIELD OF THE INVENTION

The present invention generally relates to the field of wireless tags and/or devices such as high frequency (HF), ultrahigh frequency (UHF), radio frequency (RF) and/or RF identification (RFID) tags and devices. More specifically, embodiments of the present invention pertain to reader hardware, software, and/or firmware features which tolerate spurious bits that a wireless integrated circuit without an on-board Power-On-Reset circuit (e.g., a “POR-less integrated circuit/chip”) may transmit upon being energized, as well as methods for validating code from such circuits.

### DISCUSSION OF THE BACKGROUND

Wireless devices, such as surveillance and/or identification tags, often do not include a power-on-reset circuit, and therefore may transmit spurious information (e.g., inconsistent or inaccurate bits of data) to a reader upon being energized. Such spurious bits can be transmitted because the POR-less integrated circuit or chip might “wake up” in a partially-energized state (for example, a state in which ROM scanning has not yet been initiated, but a bit encoder and/or modulator can cause invalid bits to be transmitted from the tag back to the reader). Spurious bits can also be transmitted because the absence of a POR circuit allows the integrated circuit to begin operating and transmitting bits before it has enough voltage or current to reliably operate the entire integrated circuit for the duration of the transmission. This can also happen at the edge of the read range, where the power supplied by the reader is relatively weak.

For example, FIG. 1 provides a diagram showing a transmission of bits from a wireless device or integrated circuit to a reader over a period of time, relative to the available integrated circuit supply voltage. As shown in FIG. 1, initially (e.g., when the chip “wakes up”), there is insufficient supply voltage for the integrated circuit to transmit a valid transmission code to the reader. However, over time, the integrated circuit supply voltage increases, and eventually reaches the minimum voltage required for reliable or valid transmission of the bits (e.g., of validation code). If the integrated circuit transmits code before the minimum supply voltage for reliable transmission is attained, the tag can transmit spurious or inaccurate bits, and thus the reader does not receive a valid code. However, if the spurious bits can be suppressed or prevented, the integrated circuit is able to submit a valid bit string.

### SUMMARY OF THE INVENTION

Embodiments of the present invention relate to methods, algorithms, architectures, circuits, and/or systems for reading POR-less wireless integrated circuits.

A first aspect of the present invention relates to methods of validating code from a wireless device. In general, the method of validating code comprises (i) broadcasting a signal from a reader to a wireless device, (ii) reading a validation code transmitted, re-radiated, and/or backscattered from the wireless device, the validation code having a predetermined quality, characteristic, and/or property, (iii) comparing the validation code to a reference quality, characteristic, and/or property, and (iv) validating the validation code when the predetermined quality, characteristic, and/or property matches the reference quality, characteristic, and/or property.

In one embodiment, the validation code comprises a predetermined number of bits and the reference quality, characteristic, and/or property consists of an expected number of bits. In this embodiment, the validation code is validated when the predetermined number of bits matches the expected number of bits. In a second embodiment, a validation code can be transmitted, re-radiated, and/or backscattered a plurality of times in succession, and the validation code will be validated if each of the transmitted, re-radiated, and/or backscattered codes match one another.

In some variations, the method may further comprise storing a list of validation codes that were transmitted, re-radiated, and/or backscattered from a plurality of wireless devices in a memory of the reader. In this method, a newly received code is compared to the list of stored validation codes. If the newly received code matches one or more codes in the list, the newly received code is validated and added to the list of codes. If the newly received code does not match at least one code on the list, then the newly received code is not validated. In preferred embodiments, the list of validation codes is reset periodically (e.g., after a predetermined period of time, after the reader suspends power to the wireless devices that are within the read field or broadcast field, etc.).

A second aspect of the present invention relates to a reader or a system for validating a code transmission. For example, an exemplary reader for validating a code transmission can include: (i) an antenna configured to broadcast a wireless signal; (ii) a wireless communication module configured to modulate the wireless signal to be broadcast by the antenna and/or demodulate a response transmitted, re-radiated, or backscattered from a wireless device, the response comprising a validation code having a predetermined quality, characteristic, and/or property; (iii) a validation circuit configured to compare the predetermined quality, characteristic and/or property to a reference quality, characteristic, and/or property, and validate the validation code when the validation code received matches the reference quality, characteristic and/or property; and (iv) a controller configured to process, convey, and/or manage communication(s) with the wireless device.

A third aspect of the present invention relates to devices (e.g., wireless integrated circuits, tags, etc.) suitable for use with the methods and systems of the present invention. In one exemplary embodiment, a device includes: (i) an antenna configured to receive a wireless signal from a reader and re-radiate, broadcast, or backscatter a response signal, the response signal comprising a validation code having a predetermined quality, characteristic, and/or property; (ii) a wireless communication circuit coupled to the antenna, the wireless communication circuit configured to demodulate or otherwise process the wireless signal and modulate an absorption of the wireless signal to provide the response signal; and (iii) a response circuit comprising (a) a memory including a validation code storage area, and (b) a response generator configured to transmit the validation code. In some embodiments, the device may further comprise a battery, and the device can be configured to initiate the wireless communication with the reader.

Embodiments of the present invention provide methods, systems, and devices for reading tags configured to operate in accordance with a “tag-talks-first” protocol, using a reader based on an ISO14443 Type A protocol (see, e.g., U.S. Patent Application Publication No. 2007/0126556 [Attorney Docket No. IDR0642], the relevant portions of which are incorporated herein by reference). Specifically, the methods and systems of the present invention can advantageously provide a reliable approach for managing, reading and/or validating a wireless integrated circuit, device, or tag that does not incorporate a POR circuit. In addition, the invention further relates to multi-tag system implementations of the present architectures, methods, and circuits. For example, embodiments of the present invention can advantageously allow an Aloha-type anti-collision function to be implemented in a reader based on POR-less integrated circuits and/or tags. These and other advantages of the present invention will become readily apparent from the detailed description of preferred embodiments below.

### BRIEF DESCRIPTION OF THE DRAWINGS

FIG. 1 is a diagram showing transmission of bits from a wireless device to a reader over a period of time, relative to the available integrated circuit supply voltage.

FIG. 2 is a flow diagram showing a first exemplary method of validating a code transmission in accordance with embodiments of the present invention.

FIG. 3 is a flow diagram showing a second exemplary method of validating a code transmission in accordance with embodiments of the present invention.

FIGS. 4A-4I illustrate the steps of a third exemplary method of validating code transmission using an Aloha-type anti-collision scenario.

FIG. 5 is a flow diagram showing the method of FIGS. 4A-4C.

FIG. 6 is an exemplary block schematic diagram showing an exemplary system for validating a code transmission suitable for use in accordance with embodiments of the present invention.

FIG. 7 is an exemplary block schematic diagram showing a device design suitable for used in accordance with embodiments of the present invention.

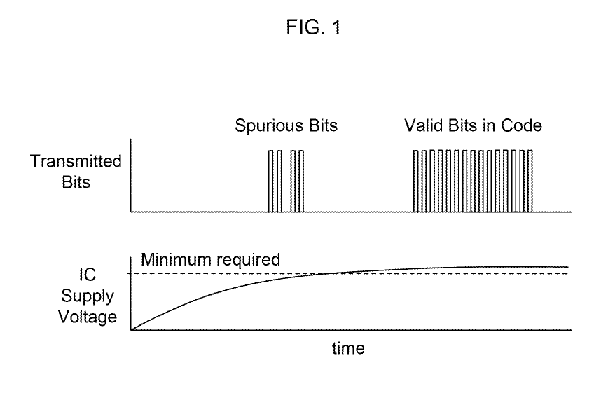

### DETAILED DESCRIPTION OF THE PREFERRED EMBODIMENTS

Reference will now be made in detail to preferred embodiments of the invention, examples of which are illustrated in the accompanying drawings. While the invention will be described in conjunction with certain preferred embodiments, it will be understood that the description is not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

For convenience and simplicity, the terms “clock,” “time,” “timing,” “rate,” “period” and “frequency” are, in general, interchangeable and may be used interchangeably herein, but are generally given their art-recognized meanings Also, for convenience and simplicity, the terms “data,” “data stream,” “code,” “bits,” “bit string,” “waveform” and “information” may be used interchangeably, as may the terms “connected to,” “coupled with,” “coupled to,” and “in communication with,” (which may refer to direct or indirect connections, couplings, or communications) but these terms are generally given their art-recognized meanings herein. Additionally, the terms “code,” “validation code,” “identification code,” “standard code,” and “identifying code protocol” may be used interchangeably, and generally refer to a bit string transmitted, re-radiated, and/or backscattered from an integrated circuit or wireless device to a reader. Further, the terms “device,” “wireless device,” “integrated circuit,” “wireless IC,” and “tag” may be used interchangeably, and may refer to a single device or to a sheet and/or a spool comprising a plurality of attached structures, suitable for electronic article surveillance (EAS), high frequency (HF), ultrahigh frequency (UHF), radio frequency (RF) and/or RF identification (RFID) functions and/or applications. Furthermore, in the context of this application, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use, unless otherwise indicated from the context of the disclosure herein.

Relatively low cost manufacturing methods, including printing techniques, such as laser printing, inkjet printing, gravure printing, screen printing, offset printing, flexography, syringe dispensing, microspotting, stenciling, stamping, pump dispensing, pen-coating, laser forward transfer, local laser CVD, and/or laser definition technology using ink-based metal and/or semiconductor nanoparticles and/or liquid phase silanes, liquid-phase metal compounds, salts, or complexes, oligosilanes and/or polysilanes may be used in accordance with embodiments of the present invention (see, e.g., U.S. Pat. Nos. 7,687,327, 7,485,691, 7,286,053, 7,619,248, 7,674,926, 7,152,804, 7,498,015, 7,294,449, and/or 7,276,385, and U.S. patent application Ser. Nos. 11/243,460 and 11/203,563 [Attorney Docket Nos. IDR0272 and IDR0213, respectively], respectively filed on Oct. 3, 2005 and Aug. 11, 2005, the relevant portions of which are incorporated herein by reference). For example, semiconductor layers (e.g., containing doped and/or undoped silicon or silicon-germanium) can be printed from an ink comprising silicon and/or germanium nanoparticles and/or a liquid-phase silane, germane and/or silagermane in a suitable solvent. Metal layers may be printed from an ink comprising nanoparticles of a metal (such as silver, copper, gold, palladium, molybdenum, aluminum, etc.) in a suitable solvent. Preferred solvents include an alkane, a monocycloalkane, a bicycloalkane, a substituted monocycloalkane, a substituted bicycloalkane, a (cyclic) siloxane, a fluoroalkane, and/or cycloalkanes such as cyclohexane, cyclooctane, decalin, etc. (see, e.g., co-pending U.S. patent application Ser. Nos. 12/131,002 and 12/243,880, respectively filed on May 30, 2008 and Oct. 1, 2008 [Attorney Docket Nos. IDR1263 and IDR1574, respectively], the relevant portions of which are incorporated herein by reference).

Exemplary Methods of Validating Code from a Wireless Device

A first exemplary method of validating code from a wireless device generally comprises the steps of: (i) broadcasting a signal from a reader to the wireless device; (ii) reading a validation code transmitted, re-radiated, and/or backscattered from the wireless device, the validation code having a predetermined quality, characteristic, and/or property; (iii) comparing the validation code to a reference quality, characteristic, and/or property; and (iv) validating the validation code when the predetermined quality, characteristic, and/or property matches the reference quality, characteristic, and/or property. Wireless devices suitable for use with the method(s) of the present invention can comprise an identification and/or surveillance tag (e.g., a HF, UHF, LF, VHF, RF, and/or RFID tag).

In one exemplary embodiment, the validation code comprises a predetermined number of bits, and the reference quality, characteristic, and/or property consists of an expected number of bits. In this embodiment, the validation code is validated when the predetermined number of bits matches the expected number of bits. If the predetermined number of bits does not match the expected number of bits, then the validation code is not validated. For example, if the reader is expecting to receive a 128-bit code, it will ignore any transmission consisting of any other number of bits, either fewer than 128, or more than 128. In some implementations, the predetermined number of bits is 2ⁿ bits, where n is greater than or equal to 2 (e.g., 16 bits, 64 bits, 128 bits, 256 bits, etc.), but other numbers of bits are equally suitable. In an alternative embodiment, the reference quality, characteristic, and/or property consists of a predetermined pattern of bits (e.g., 010101) at a predetermined location in the code (e.g., beginning, end, specific bit number in sequence, etc.). In other alternative embodiments, the reference quality, characteristic, and/or property consists of a predetermined amplitude (e.g., for at least a predetermined minimum amount of time), or a predetermined power density.

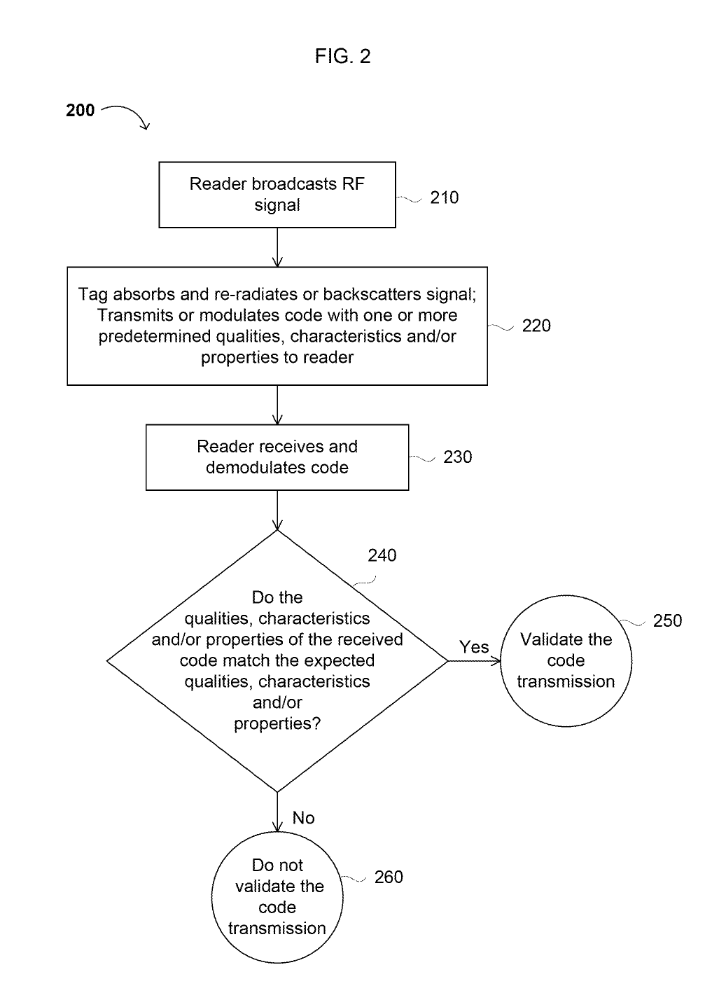

This exemplary embodiment is shown in the flow diagram of FIG. 2, and is indicated by the general reference character 200. As shown in step 210, a reader broadcasts a wireless signal. In one embodiment, the wireless signal is in the RF band of the spectrum. In other embodiments, the wireless signal is in another band (e.g., HF, VLF, LF, MF, VHF, UHF, Radar Frequency, International Telecommunications Union (ITU) designated radio bands 2 [30-300 Hz], 3 [300 Hz-3000 Hz], 4 [3-30 kHz], 5 [30-300 kHz], 6 [300-3000 kHz], 7 [3-30 MHz], 8, [30-300 MHz], 9 [300-3000 MHz], and 10 [3-30 GHz]; and European Union/North Atlantic Treaty Organization designated radio bands A [0-0.25 GHz], B [0.25-0.5 GHz], C [0.5-1 GHz], D [1-2 GHz], E [2-3 GHz], F [3-4 GHz], G [4-6 GHz], H [6-8 GHz], I [8-10 GHz], J [10-20 GHz], and K [20-40 GHz], etc.) of the spectrum. A wireless device or tag within a read or broadcast field of the reader absorbs and re-radiates or backscatters the signal (see step 220). In a typical example, the tag transmits or modulates the validation code to the reader when re-radiating or backscattering the wireless signal from the reader.

As shown in step 230, the reader then receives and demodulates the validation code. In general, the validation code has one or more predetermined qualities, characteristics, and/or properties. For example, in one embodiment, the predetermined quality, characteristic, and/or property comprises a predetermined number of bits. In an alternate embodiment, the predetermined quality, characteristic, and/or property comprises a minimum power density transmission. In another variation, the predetermined quality, characteristic, and/or property comprises a predetermined pattern of data bits (e.g., 010101, 00111, etc.). In still another implementation, the predetermined quality, characteristic, and/or property comprises a predetermined minimum amplitude for a predetermined minimum amount of time.

As shown in step 240, the reader compares quality, characteristic, and/or property of the code to a reference or expected quality, characteristic, and/or property. To illustrate, in embodiments where the predetermined quality, characteristic, and/or property comprises a predetermined number of bits, the reader compares the number of bits received from the wireless device or tag to the reference number or expected number of bits. In such embodiments, if the number of bits received matches the predetermined or expected number of bits, the code transmission is validated (see step 250). If the number of bits received does not match the predetermined or expected number of bits, the code transmission is not validated (see step 260).

In some variations, a comparator and/or logic in the reader compares the predetermined quality, characteristic, and/or property of the code transmitted, re-radiated, and/or backscattered from the wireless device, and validates the code transmission when the predetermined quality, characteristic, and/or property of the code transmitted matches the expected or reference quality, characteristic, and/or property.

In another exemplary embodiment, the method generally comprises comparing a first code (e.g., validation code) from a first transmission, re-radiation, and/or backscattering from a wireless device to a second code from a second transmission, re-radiation, and/or backscattering from the same device. In other words, the wireless device or tag transmits its validation code more than once in succession. In this embodiment, the code is validated when the first and second validation codes match. For example, in some implementations, the same code must be received at least twice in succession (or, alternatively, 3 or 4 times in succession) before the code is validated. In some variations, a comparator and/or logic in the reader compares each of the transmitted, re-radiated, or backscattered codes to one another, and validates the transmission when the each of the codes match.

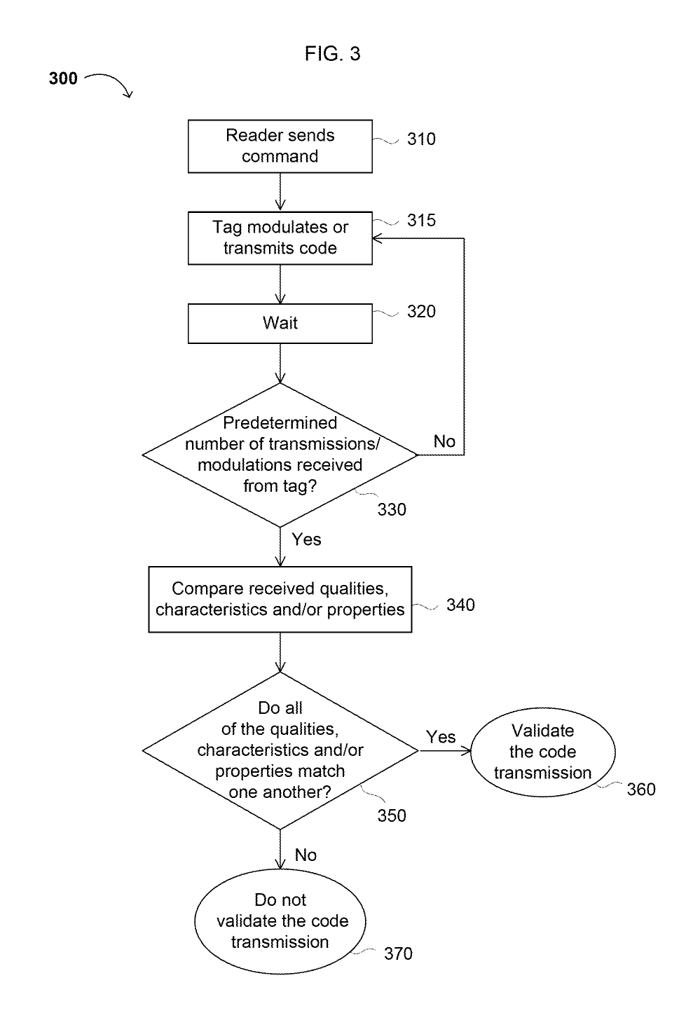

This exemplary embodiment is shown in the flow diagram of FIG. 3, and is indicated by the general reference character 300. As shown in step 310 a reader sends a command to a wireless device or tag. The tag demodulates and processes the command, and in response, the tag modulates or transmits its (validation) code to the reader (step 315). Then, the tag waits for a pre-determined period of time (see step 320). The reader determines if the predetermined number of occurrences of the code quality, characteristic, and/or property (e.g., number of transmissions or modulations, number of minimum power density transmissions, number of occurrences of a predetermined pattern [e.g., 010101, 00111, etc.], number of occurrences of a predetermined minimum amplitude for a predetermined minimum amount of time, etc.) have been received from the tag (see step 330). If the predetermined number of occurrences of the code quality, characteristic, and/or property has not been received, then the tag modulates or transmits its code again (see step 315). This loop continues until the predetermined number of occurrences of the code quality, characteristic, and/or property has been received by the reader.

Once the predetermined number of occurrences of the code quality, characteristic, and/or property have been received, a predetermined quality, characteristic, or property of each of the codes is compared, as shown in step 340. If the predetermined qualities, characteristics, or properties of all of the codes received match one another (step 350), then the code transmission is validated (step 360). If all of the predetermined qualities, characteristics, or properties of all the codes received do not match one another, the code transmission is not validated (see step 370).

In some implementations, any of the above-described embodiments may be used in an Aloha-type anti-collision scenario. For example, two or more wireless devices or tags within a read field or broadcast field of a reader might transmit, re-radiate or backscatter valid codes, but at slightly different times. In addition, the wireless devices or tags might re-transmit their validation codes at different intervals. Any newly arriving code is compared (e.g., by a comparator or logic) to one or more codes stored on a list of approved or validated codes in the reader memory (e.g., non-volatile memory) to avoid rejecting the new code as invalid simply because it was preceded by a different code from a different tag. The reader memory can be implemented as read only Memory (ROM), electrically erasable programmable read only memory (EEPROM), static random access memory (RAM), latches, programmable connections (e.g., fuses), and/or any other suitable information storage circuit/device known in the art. In general, the reader memory may comprise from about 4 bytes (e.g., 32 bits) to thousands of bits (e.g., 2,000 bits, 4,000 bits, 8,000 bits, etc.) or any range of values therein.

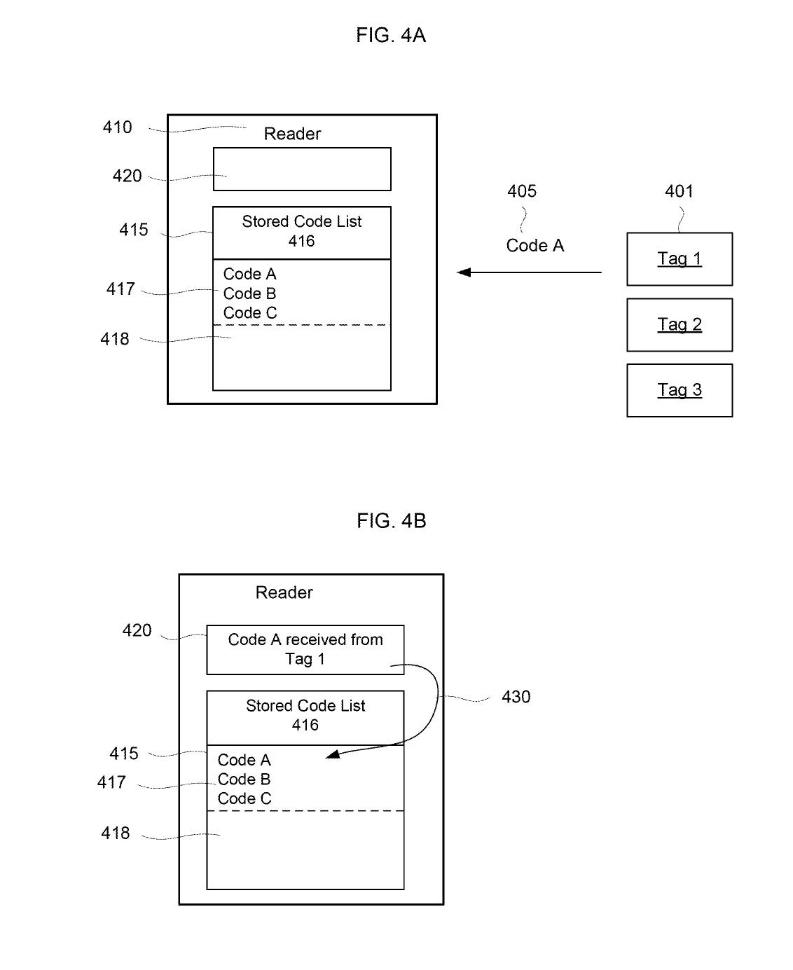

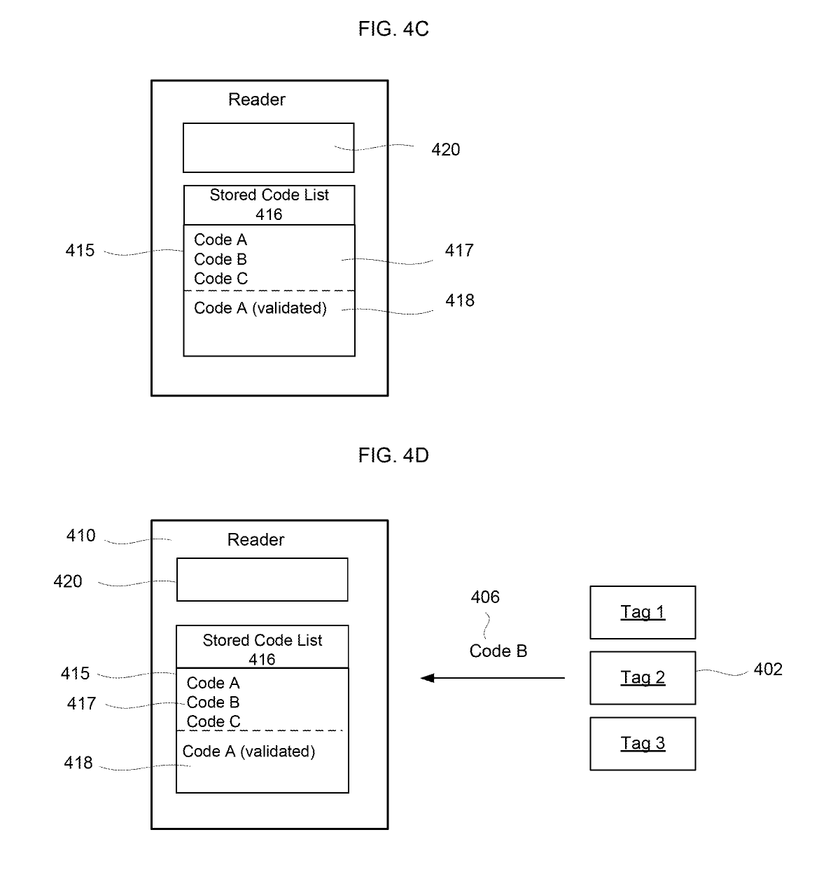

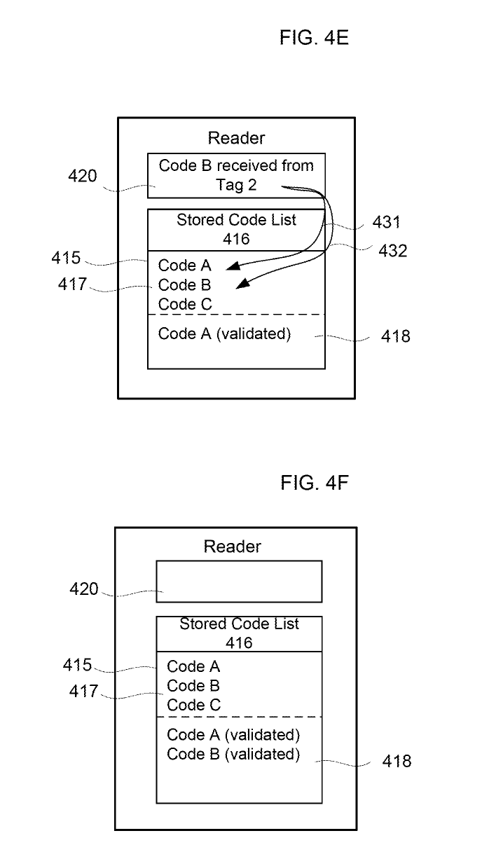

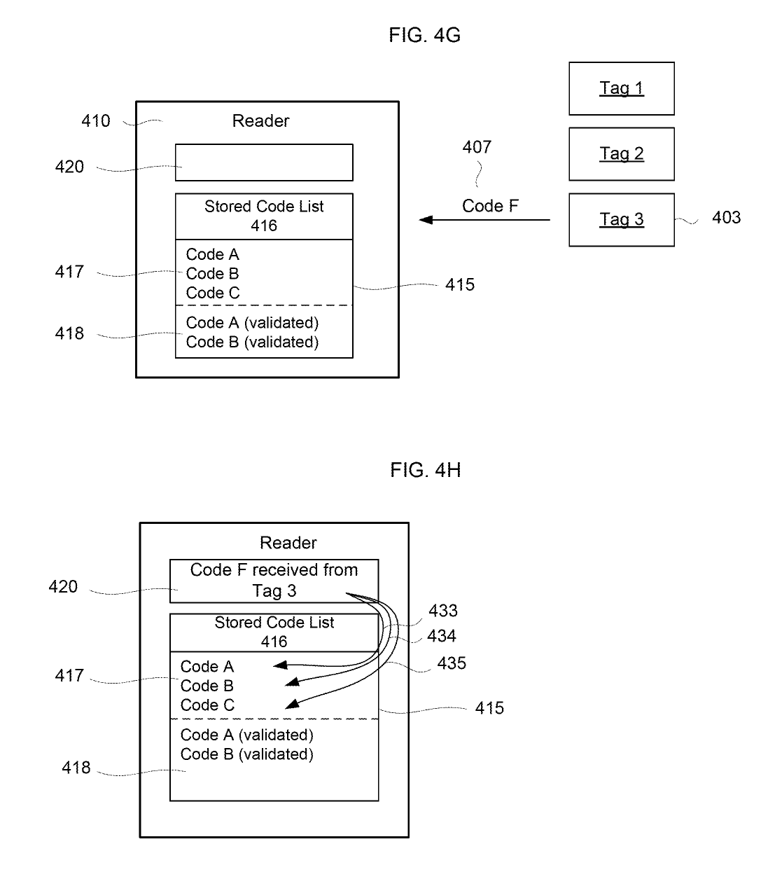

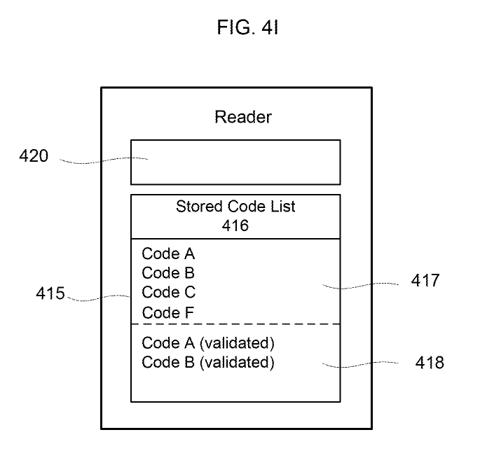

The steps of such an embodiment are illustrated in FIGS. 4A-4I. As shown in FIG. 4A, a first tag (e.g., “Tag 1”) 401 transmits a first code (e.g., “Code A”) 405 to a reader 410 configured to store a list of “pre-validated” or approved codes 416 in a first memory, and one or more received codes 420 in a second memory (e.g., a temporary storage device) or a second portion of the first memory 415. The list of approved codes 416 may include from several to tens or hundreds (or more) codes. Referring to FIG. 4B, the reader compares the received Code A to each of the codes stored on the list 416. For example, newly received Code A is compared to the first code (Code A) stored on the list (see, e.g., reference character 430 in FIG. 4B). If the code matches, then the newly received Code A is validated, and stored on a list of validated codes (see, e.g., reference character 418 of FIG. 4C). The list of validated codes can be stored in a separate memory (e.g., non-volatile memory) or a different portion (e.g., page or block) of the same memory (see reference character 418 of FIGS. 4A-4C).

In one embodiment, the code transmission is received by the reader and then stored in a volatile memory 420 (e.g., a series or bank of latches, a register, etc.). After the code is stored in the volatile memory, it is compared to the other codes in a list of received codes stored in a memory 415 (e.g., volatile or non-volatile memory). If the newly received code in the volatile memory 420 is on the list of codes stored in the memory 415, the newly received code is added to a list of validated codes in memory or memory portion 418. The code can then be replaced in the volatile memory 420 with another code transmission from a tag in the read field or broadcast field.

Referring now to FIG. 4D, a second tag (e.g., “Tag 2”) 402 transmits a second code (e.g., “Code B”) 406 to the reader 410. As shown in FIG. 4E, Code B is stored in volatile memory 420. Next, at 431, the reader compares the newly received Code B to the first code on the list. As shown in FIG. 4E, if the newly received Code B does not match the first code stored on the list, then at 432, the reader compares Code B to the second code on the list. If the newly received code matches the second stored code on the list, then the newly received Code B is validated and added to the list of validated codes in memory portion 418 (FIG. 4F). In a separate operation, the codes stored on the list of validated codes 418 may be compared to a list of pre-approved codes for authentication and/or proof of authenticity.

Next, for example, a third tag (“Tag 3”) 403 transmits a third code (“Code F”) 407 to the reader 410, as shown in FIG. 4G. Code F is stored in volatile memory 420 (FIG. 4H), then at 433, the reader compares the newly received Code F to the first code on the list. If the codes do not match (as is the case in FIG. 4H), the reader then compares the newly received Code F to the second code on the list at 434. If the codes do not match, the reader continues comparing the newly received Code F to the remaining codes on the list (e.g., Code C at 435, etc.) to determine if there is a match. As shown in FIG. 4I, if Code F does not match any of the codes stored on the list of codes, Code F is stored in the list of received codes 417, but is not validated (or stored in the validated code list 418).

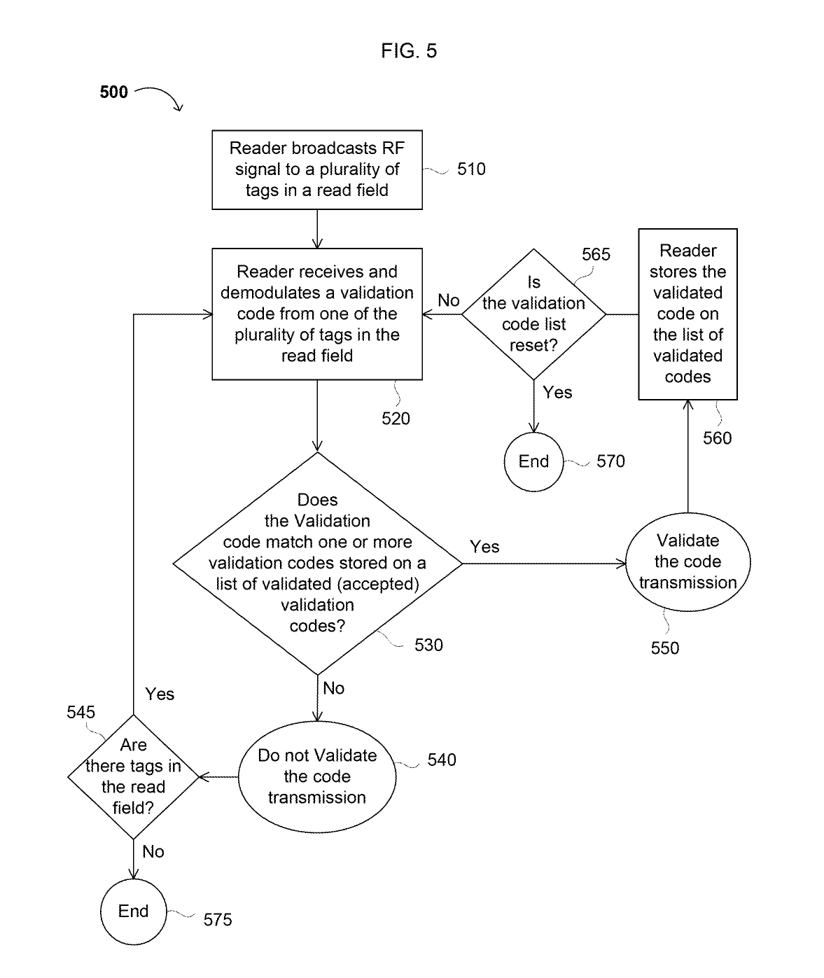

The reader can reset the validation code list after a period of time, or after the power is suspended to the wireless devices (e.g., to reset the devices, etc.), as discussed in detail below with regard to FIG. 5. In general, the memory of the reader can be adapted to store of from 2 to 1,000,000 or more validation codes (e.g., a minimum of 2, 4, 8, 10, 16, 20, etc. and/or a maximum of 64, 256, 1,000, 4,000, 16,000, or no maximum number).

FIG. 5 is a flow diagram showing the steps of the method for validating a code transmission using the Aloha-type anti-collision protocol, as indicated by the general reference character 500. As shown in step 510, a reader broadcasts a wireless signal to a plurality of tags. The reader receives and demodulates a code (e.g., validation code) from one of the plurality of tags in the read field and compares the received validation code to a list of “pre-validated” (e.g., previously accepted) validation codes (see steps 520 and 530, respectively).

As described in detail above, if the newly received code matches one of the codes stored on the list, then the code transmission is validated and stored on the list of accepted codes (see steps 550 and 560). In one embodiment, the validated codes are stored in a non-volatile memory.

Referring back to step 530 of FIG. 5, in the alternative, if the newly received code does not match one of the validation codes stored on the list, the code transmission is not validated (see step 540) and the code received is not added to the validated code list. As shown in step 545, the reader then determines if there are any tags in the read field (e.g., by sensing absorption of RF energy, detecting backscattering of a harmonic signal, etc.). If there are tags in the read field, the reader receives and demodulates another code from a tag in the read field (see step 520), and the process continues. If there are no tags in the read field, then the validation process ends (see step 575).

If the reader RF transmission times out or is otherwise terminated, the validation code list is reset (see step 565). As long as the RF signal is broadcast, the validation code list is not reset, and the reader receives and demodulates another code from one of the tags in the read field (step 520). The validation process (e.g., beginning with step 530) repeats. However, when the RF transmission ends or the stored code list is otherwise rest (e.g., by a controller in the reader or other device issuing a reset command) the validation process can end (step 570).

Any of the above described embodiments can be implemented in both a Tag-Talks-First (TTF) and a Reader-Talks-First (RTF) protocol. In general, the reader identifies a single transmitted code by a first predetermined silent period (or gap in time) before the code transmission, and a second predetermined silent period (or gap in time) after the code transmission. In some variations, the first predetermined silent period before the transmission has a length equal to the length of the second predetermined silent period.

Furthermore, in any of the above embodiments or variations, the method may further comprise instructing the wireless device to perform or not to perform an action when the transmitted code is validated. In some variations, validating the code transmission can further comprise activating or deactivating the wireless device. In other variations, the method can further comprise communicating and/or displaying the validation status of the code transmission to a user interface. In such embodiments, the user interface can receive an active validation signal/indication from logic configured to determine when the transmitted code has or has not been validated, in which case the user interface displays a positive validation indication (e.g., box or field on a visual display changing from red to green, a pop-up window or display showing an “ACCEPTED” or “VALIDATED” label, etc.). In some variations, the method can also comprise communicating a signal to alert the user that the code has or has not been validated. For example, a warning signal may be generated if the code is not validated. Similarly, it is also possible to generate a confirmation indication signal when the code has been validated or approved.

In exemplary embodiments, the alert signal (e.g., warning and/or confirmation signals) comprises sensory feedback. For example, such warning signals and/or confirmation indications may include a visual and/or audible confirmation (e.g., a red light and/or a buzzer as a warning indicator; a green light and/or a bell as a confirmation indicator, etc.). However, the warning signals and/or confirmation indications are not limited to only visual and/or audible indicators. For example, the warning signals/confirmation indications may be displayed on a computer for the user, and/or include any other type of sensory feedback, such as tactile indicators (e.g., a silent vibrating device) or olfactory indicators (e.g., release of a pleasant scent). Alert signals are discussed in detail below with regard to exemplary wireless systems for validating a code transmission.

Exemplary Wireless Systems for Validating a Code Transmission

Wireless systems for validating a code transmission include a reader generally comprising: (i) an antenna configured to broadcast a wireless signal; (ii) a wireless communication module configured to modulate the wireless signal to be broadcast by the antenna and/or demodulate a response transmitted, re-radiated, or backscattered from a wireless device, the response comprising a code having a predetermined quality, characteristic, and/or property; (iii) a validation circuit configured to compare the predetermined quality characteristic and/or property to a reference quality, characteristic, and/or property, and validate the code when the code received matches the reference quality, characteristic, and/or property; and (iv) a controller configured to process, convey, and/or manage communications(s) with the wireless device. The wireless systems and/or readers described herein may be included in various hand-held or mobile communication devices, such as a scanner, a pager, a mobile (e.g., cellular) or smart telephone handset, communicator-type devices, media players, personal data/digital assistants (PDAs), a mobile PC, and/or other hand-held wireless devices.

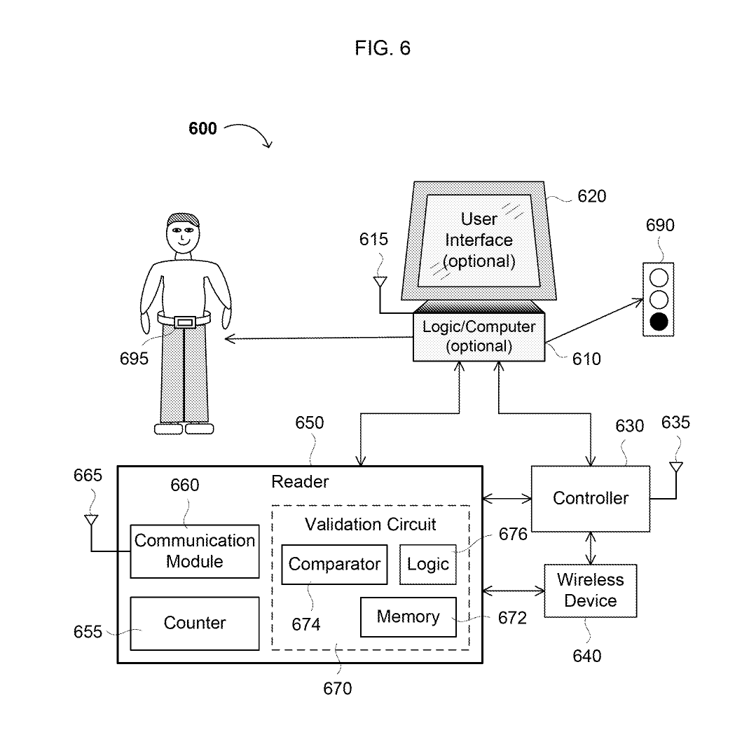

An exemplary wireless system 600 for validating a code transmission is shown in the block schematic diagram of FIG. 6. System 600 includes reader 650, controller 630, wireless device (tag 640) and optionally computer/logic 610, user interface 620, and validation display 690. As shown in FIG. 6, the reader 650 includes a wireless communication module 660 coupled to antenna 665. In general, the wireless communication module 660 is configured to produce a wireless signal (e.g., VLF, LF, RF, HF, VHF, UHF, etc.) and to receive and demodulate a response from a wireless device, integrated circuit, or tag absorbing the wireless signal. The antenna 665 is configured to broadcast the wireless signal, and receive a response that is transmitted, re-radiated, or backscattered from one or more wireless devices, integrated circuits, or tags (e.g., 640) within the read field or broadcast field of the reader. The response generally comprises a code having one or more predetermined quality(ies), characteristic(s), and/or property(ies).

The reader 650 also includes a validation circuit 670, which is generally configured to compare the predetermined qualities, characteristics, and/or properties of the code received from the tag or wireless device to an expected reference quality, characteristic, and/or property (e.g., expected number of bits, expected bit pattern at an expected location in the code, expected amplitude and/or power density, etc.). The validation circuit 670 validates the validation code received from the tag or device when the quality, characteristic, and/or property of the received validation code matches the reference quality, characteristic, and/or property. In exemplary embodiments, the validation circuit includes a comparator 674, logic 676, and a memory 672. The memory 672 is generally configured to store the reference quality, characteristic, and/or property. The comparator 674 and/or logic 676 are generally configured to determine when the quality, characteristic, and/or property of the code received from the tag matches the reference quality, characteristic, and/or property.

To illustrate, in one exemplary embodiment, the predetermined quality, characteristic, and/or property comprises a predetermined number of bits, and the reference quality, character, and/or property comprises an expected (or acceptable) number of bits. In this embodiment, the validation circuit 670 is configured to validate the code from the tag or device only if the number of bits transmitted, re-radiated, or backscattered from the tag matches the expected number of bits (e.g., stored in the reader memory 672). If the number of bits in the transmitted code do not match the expected number of bits, the validation circuit will not validate code.

In another exemplary embodiment, the wireless communication module 660 can comprise a modulator and/or demodulator/data recovery circuit, one or more filters coupled to each, and a latch/register (volatile memory) configured to store (temporarily) code received from a tag. In general, the wireless communication module 660 is configured to demodulate a plurality of successive responses transmitted, re-radiated, or backscattered from a wireless device 640, and the validation circuit 670 is configured to compare each of the plurality of successive responses to one another. For example, the wireless communication module 660 can be configured to demodulate 2, 3, 4, or more successive codes transmitted from a wireless device, and compare a predetermined quality, characteristic, or property of each of the 2, 3, 4, or more successive codes to one another. The validation circuit 670 will validate the code transmission only if the predetermined qualities, characteristics, or properties of all of the codes received match one another. In embodiments comprising a comparator 674 and/or logic 676, one or both of these components can process the plurality of successive responses, determine whether the plurality of successive responses having matching predetermined qualities, characteristics, or properties, and then validate the response if the predetermined qualities, characteristics, or properties match.

In general, the reader 650 is configured to identify a single transmitted code by first and second pre-determined silent periods before and/or after the response during which no bits are received by the reader. The length(s) of the first and/or second predetermined silent periods may be programmed into the memory (e.g., 672) of the reader. In some implementations, the length of the first and/or second predetermined silent periods can be determined by a counter 655. In other exemplary embodiments, the length of the first predetermined silent period is equal to the length of the second predetermined silent period.

In some embodiments, the reader 650 can receive and demodulate a plurality of codes transmitted, re-radiated, or backscattered from a plurality of wireless devices or integrated circuits within a predetermined read field or broadcast field of the reader. The reader memory 672 (e.g., non-volatile memory, etc.) can be configured to store a list of the plurality of codes transmitted and validated from the plurality of wireless devices. For example, the memory 672 can be configured to store of from 2 to 1,000,000 validation codes or more. In such embodiments, the validation circuit 670, the comparator 655, and/or the logic 670 in the reader 650 can be configured to compare each of the plurality of validation codes received to the approved codes stored on the list in the memory 672 (see, e.g., FIGS. 4A-4C and FIG. 5).

Referring still to FIG. 6, the reader 650 further comprises (or communicates with) a controller 630 coupled to an antenna 635. The controller 630 is generally configured to process, convey, and/or manage communications(s) with the wireless device 640. In some variations, the controller 630 may also communicate with a user interface 620 to display code transmission validation data to a user (i.e., alerting the user that the validation code from a device or tag has or has not been validated).

The user interface 620 may be coupled to user interface logic 610, which is configured to determine when the code has (or has not been) validated, and then communicate a signal to alert the controller or a user of the validation status of the tag. For example, the user interface logic 610 may be configured to generate and transmit a confirmation signal to the user interface when a code has been validated. Alternatively or additionally, the user interface logic 610 can be configured to generate and transmit a warning signal when a code has not been validated.

In some embodiments, the validation system may include one or more user indicators configured to communicate with the user interface 620 and the user interface logic 610, and provide sensory feedback to the user regarding the validation code status of a wireless device 640 in the read field. In some variations, the user indicator can be a tactile signal, such as a silent vibrating device. For example, the tactile signal may be generated by a pager attached to a belt that is worn by a user (i.e., 695 of FIG. 6). The pager can transmit a silent vibration to confirm that the tag code has or has not been validated. Alternatively or additionally, the user indicator may comprise visual, auditory, and/or olfactory signals perceived by the user. For example, a set of warning and/or confirmation lights (i.e., 690 of FIG. 6) can alert the user that a code has or has not been validated. Some or all of the activities and communication of the reader 650, the controller 630, one or more wireless devices within the read field (e.g., 640), and/or the user interface 620 can optionally be coordinated by the user interface logic 610.

The capabilities of the logic circuitry included in the wireless system (e.g., reader logic 670, user interface logic 610, etc.) are not limited to the examples described herein, and may include any relevant action that is capable of being controlled by a computer. Furthermore, any action managed or controlled by the logic circuitry may also be done using computer software. It is within the ability of one skilled in the art to design and implement such logic.

Portions of the detailed descriptions herein have been presented in terms of processes, procedures, logic, function(s), and/or other representations of operations within a computer, signal processor, controller, sensor and/or memory. These descriptions and representations are generally used by those skilled in the data processing arts to convey the substance of their work to others skilled in the art. A process, procedure, logic block, function, operation, etc., is herein, and is generally, considered to be a self-consistent sequence of steps or instructions leading to a desired and/or expected result. The steps generally include physical manipulations of physical quantities. Usually, though not necessarily, these quantities take the form of electrical, magnetic, optical, or quantum signals capable of being stored, transferred, combined, compared, and otherwise manipulated in a computer and/or signal/data processing system.

It should be borne in mind, however, that all of these and similar terms are associated with the appropriate physical quantities and are merely convenient labels applied to these quantities. Unless specifically stated otherwise and/or as may be apparent from the following discussions, it is appreciated that throughout the present application, discussions utilizing terms such as “processing,” “determining,” “displaying” or the like, refer to the action and processes of a computer or data processing system, or similar processing device (e.g., an electrical, optical, or quantum computing or processing device), that manipulates and transforms data represented as physical (e.g., electronic) quantities. The terms refer to actions, operations and/or processes of the processing devices that manipulate or transform physical quantities within the component(s) of a system or architecture (e.g., registers, memories, sensors, other such information storage, transmission or display devices, etc.) into other data similarly represented as physical quantities within other components of the same or a different system or architecture.

Although the description herein focuses on methods and hardware (e.g., architectures, systems and/or circuits), the present invention also includes a computer program and/or software, implementable and/or executable in a general purpose computer or workstation equipped with conventional digital and/or analog signal processor(s), configured to perform one or more steps of the method and/or one or more operations of the hardware. Thus, a further aspect of the invention relates to software that implements the above method(s) and/or algorithm(s). For example, the invention may further relate to a computer-readable medium comprising a computer-executable set of instructions stored thereon which, when executed by an appropriate signal processing device, is configured to perform the methods described herein. For example, the computer-readable medium may comprise any medium that can be read by a signal processing device configured to read the medium and execute code stored thereon or therein, such as a floppy disk, CD-ROM, magnetic tape or hard disk drive. Such code may comprise object code, source code and/or binary code.

The code is generally configured for transmission through an appropriate medium, such as copper wire, a conventional network cable, a conventional optical data transmission cable, or even air or a vacuum (e.g., outer space) for wireless signal transmissions. The code is generally digital, and is generally configured for processing by a conventional digital data processor (e.g., a microprocessor, microcontroller, or logic circuit such as a programmable gate array, programmable logic circuit/device or application-specific [integrated] circuit).

Exemplary Wireless Devices

Exemplary wireless devices or tags suitable for use with the methods and the systems of the present invention generally comprise (i) an antenna configured to receive a wireless signal from a reader and re-radiate, broadcast, or backscatter a response signal, the response signal comprising a validation code having a predetermined quality, characteristic, and/or property; (ii) a wireless communication circuit coupled to the antenna, the wireless communication circuit configured to demodulate or otherwise process the wireless signal and modulate an absorption of the wireless signal to provide the response signal; and (iii) a response circuit comprising (a) a memory including a validation code storage area, and (b) a response generator configured to transmit the validation code.

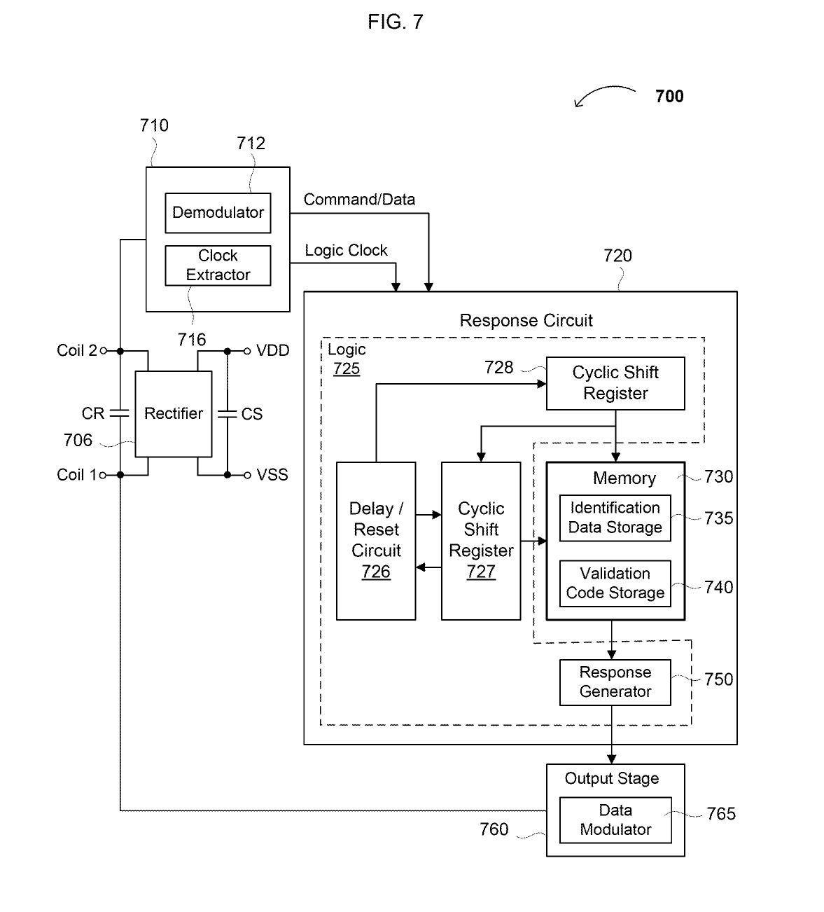

An exemplary wireless device design suitable for use in accordance with embodiments of the present invention is shown in the block schematic diagram of FIG. 7, and is indicated by general reference character 700. In general, an external antenna attached at terminals Coil 1 and Coil 2 and across capacitor CR can detect an electromagnetic field, and generate or extract power and/or a data signal therefrom when the electromagnetic field has sufficient strength. Although not shown in FIG. 7, the antenna can comprise a coil having a plurality of loops or rings. Any number of loops, rings, or coils may be employed, depending on the manufacturing technology, application requirements, and design choices and/or preferences. Furthermore, the antenna can take any form and/or shape conventionally used for such antennas. However, in exemplary embodiments the antenna has a coil, or concentric spiral loop form. For ease of manufacturing and/or device area efficiency, the coil loops preferably have a square or rectangular shape. However, the coil loops may also have an octagonal, circular, rounded or oval shape, some other polygonal shape, or any combination thereof. The coil loops can have one or more truncated corners according to and/or depending on manufacturing, application and/or design choice or preferences, as long as each successive loop is substantially entirely positioned between the preceding loop and the outermost periphery of the wireless device.

In some implementations, a backing and/or support layer may be attached to the antenna. The support and/or backing layer may provide an adhesive surface for attachment to or placement of the wireless device to an article or product (e.g., an item that is to be tracked or monitored). Exemplary antennas and methods of making antennas are described in detail in U.S. Pat. Nos. 7,286,053, 7,152,804, 7,387,260, and 7,675,464, and in U.S. patent application Ser. Nos. 12/249,735 and 12/249,754 (Attorney Docket Nos. IDR1412 and IDR1462, respectively), filed on Oct. 10, 2008 and Oct. 10, 2008, respectively, the relevant portions of which are incorporated herein by reference.

The wireless device 700 further comprises a rectifier 706 configured to receive a signal from the antenna. Specifically, the AC voltage across the coil can be rectified by rectifier 706 (e.g., a full wave, half-wave, or bridge rectifier) to form a DC supply across terminals VDD/VSS and supply capacitance, CS. The wireless device further comprises a wireless communication circuit coupled to the antenna. The wireless communication circuit (e.g., a radio [RF] circuit, etc.) has an input control portion 710 connected to the antenna and the response circuit 720. The input control portion 710 may include a demodulator 712 configured to demodulate a command and/or data received from a reader or scanner (not shown), and provide a command and/or data signal to the response circuit 720. The wireless communication circuit may also comprise an output control portion 760 including a data modulator 765 configured to output the code to the reader or scanner.

In some embodiments, the wireless communication circuit comprises a clock extractor 716 that can produce a logic clock for the logic 725 in the response circuit 720. Such embodiments may also include at least one cyclic shift register (e.g., 727 and 728) configured to communicate with the memory 730 in the response circuit 720 and/or or a delay/reset circuit 726 in the logic 725. In some embodiments (e.g., where a government agency does not impose power restrictions across a particular and/or predetermined frequency band), clock extractor 716 may process a demodulated signal from the demodulator 712 (e.g., demodulator 712 and clock extractor 716 are in series). In other embodiments (e.g., when receiving a 13.56 MHz signal), the demodulator and clock extractor process the received wireless signal in parallel.

The logic 725 may be configured to receive a command and/or data signal from the demodulator 712 and/or a clock signal from the clock extractor 716, and provide an identification signal or other appropriate response thereto. The logic can include one or more cyclic shift registers 727/728, a delay/reset circuit 726, and can also include the response generator 750. It is well within the ability of one skilled in the art to design and implement such logic. Logic to perform the required control and readout (e.g., I/O) functions can be realized with transistors in CMOS or NMOS technologies, using materials known in the art. CMOS technology has a significant advantage in terms of power efficiency, but requires additional processing steps compared to NMOS technology. In various embodiments, the logic may be configured to obtain/fetch a code (e.g., validation code, identification code, etc.) or other information from the memory 730 upon one or more predetermined conditions (e.g., transmission of a computer command to read the identification data and/or the validation code, transmission of a computer command to respond to a query if particular identification data is or is not present in the memory, etc.), instruct the wireless device to perform or not perform an action (if the code is validated), and/or execute other instructions from the memory 730.

As shown in FIG. 7, the response circuit memory 730 includes a validation code storage area 740. The validation code storage area 740 is generally adapted to store at least one code (e.g., a validation code), which may be unique to the wireless device. In general, the validation code has a predetermined quality, characteristic, and/or property. For example, in one embodiment, the code may comprise a predetermined number of bits (e.g., 8 bits, 16 bits, 32 bits, 64 bits, etc.). In another embodiment, the code comprises a predetermined pattern (e.g., 010101, 001110, etc.) in a predetermined location of the bit string. In some embodiments, the memory may also include an identification data storage area 735, which may store unique identifier (UID) information, object identifier (OID) information, tag identifier (TID) information, user information, or any additional information that can be accessed with memory addresses. In addition to the validation code storage area 740 and the (optional) identification data storage area 735, the memory 730 may further include additional data storage circuits configured to store other instructions. The memory can be implemented as read only memory (ROM), electrically erasable programmable read only memory (EEPROM), static random access memory (RAM), latches, programmable connections (e.g., fuses), and/or any other suitable information storage circuit/device known in the art. In general, the memory may comprise from about 4 bytes (e.g., 32 bits) to thousands of bits (e.g., 2,000 bits, 4,000 bits, 8,000 bits, etc.) or any range of values therein.

The response circuit 720 also includes a response generator 750 configured to transmit the code stored in the validation code storage area 740. In some embodiments, the response generator 750 may be included in logic region 725 of the response circuit 720. Modulation control can be generated from the response circuit 720 (e.g., from the response generator 750 in the logic 725) and provided to data modulator 765 for output to the reader or scanner.

In implementations employing an Aloha-type anti-collision protocol, the response generator 750 can be configured to transmit one of the codes a plurality of times with a predetermined silent period before and/or after each code transmission. For example, the response circuit can be configured to transmit a code at least 2, 3, 4, or more times in succession. In some embodiments, the predetermined silent period before and/or after each code transmission can be programmed into the memory 730. Furthermore, in further implementations, the duration of the predetermined silent period can differ for each silent period.

In some embodiments, the wireless device can be configured to communicate with a reader when the device is within a sufficient electromagnetic field supplied by the reader. Although not shown in FIG. 7, in other embodiments, the wireless devices of the present invention may further include a battery, and may be configured to initiate the wireless communication with the reader or scanner.

The devices of the present invention may comprise a HF, UHF, VHF, RF or any other wireless device known in the art, and in some exemplary embodiments the device comprises an identification or a surveillance tag such as an RFID tag. The wireless devices of the present invention may have a length of from 5 to 25 mm, preferably 5 to 20 mm, a width of from 1 to 5 mm, preferably 1 to 3 mm, and an overall area of from 5 to 100 mm², preferably 10 to 50 mm². In one example, the device is 2 mm×12.5 mm.

In general, wireless devices (e.g., RF, RFID, HF, UHF, VHF, etc.) as described herein, and which are suitable for use in the present invention, receive and backscatter signals at 900 MHz. However, the wireless devices can operate at radio frequencies ranging from 125 KHz to 5.8 GHz (e.g., 125-134 KHz, 8.2 MHz, 19.5 MHz, 13.56 MHz, 868-928 MHz, 2.45 GHz), or any other frequency or range of frequencies therein. See, also, U.S. Pat. No. 7,687,327 and U.S. patent application Ser. No. 11/243,460 (Attorney Docket No. IDR0272), filed on Oct. 3, 2005, the relevant portions of which are incorporated herein by reference.

### CONCLUSION/SUMMARY

Thus, the present invention provides methods for validating code from wireless devices, apparatuses and systems for validating a code, wireless devices, and variations of the same. The methods, systems, and wireless devices of the present invention can advantageously provide a reliable approach for reading and/or validating an integrated circuit, wireless device, or tag that does not incorporate a POR circuit. Thus, the methods and systems of the present invention can reduce or eliminate the occurrence of a partial and/or incorrect wireless device reading. In addition, embodiments of the present invention advantageously allow implementation of an Aloha-type anti-collision protocol in a reader based on POR-less integrated circuits and/or tags.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of validating code from a wireless device, comprising:
a) broadcasting a signal from a reader to the wireless device;
b) reading a validation code transmitted, re-radiated, and/or backscattered from the wireless device, the validation code having a predetermined quality, characteristic, and/or property;
c) comparing the validation code to a reference quality, characteristic and/or property; and
d) validating the validation code when the predetermined quality, characteristic, and/or property of the validation code matches the reference quality, characteristic, and/or property.

2. The method of claim 1, wherein the validation code comprises a predetermined number of bits, the reference quality, characteristic, and/or property consists of an expected number of bits, and the validation code is validated when the predetermined number of bits matches the expected number of bits.

3. The method of claim 1, further comprising reading a plurality of validation codes from one or more wireless devices within a read field of the reader.

4. The method of claim 1, wherein the validation code is transmitted, re-radiated, and/or backscattered from the wireless device a plurality of times.

5. The method of claim 4, wherein each transmission, re-radiation, and/or backscattering of the validation code is preceded and/or followed by a predetermined silent period.

6. The method of claim 4, further comprising comparing a first validation code from a first transmission, re-radiation, and/or backscattering to a second validation code from a second transmission, re-radiation, and/or backscattering, and validating the validation code when the first and second validation codes match.

7. The method of claim 6, further comprising storing a list of validation codes transmitted, re-radiated, and/or backscattered from a plurality of wireless devices in a memory of the reader.

8. The method of claim 7, further comprising resetting the list after a predetermined period of time, or after the reader suspends power to the wireless devices within a read/broadcast field.

9. A computer-readable medium comprising a computer-executable set of instructions stored thereon, adapted to perform the method of claim 1.

10. The computer-readable medium of claim 9, wherein the computer-executable set of instructions is further adapted to store a plurality of validation codes in a memory in the reader.

11. A reader for validating a code transmission, comprising:
a) an antenna configured to broadcast a wireless signal;
b) a wireless communication module configured to modulate the wireless signal to be broadcast by the antenna and/or demodulate a response transmitted, re-radiated, or backscattered from a wireless device, the response comprising a validation code having a predetermined quality, characteristic, and/or property;
c) a validation circuit configured to compare the predetermined quality, characteristic and/or property to a reference quality, characteristic, and/or property, and validate the validation code when the validation code received matches the reference quality, characteristic and/or property; and
d) a controller configured to process, convey, and/or manage communication(s) with the wireless device.

12. The reader of claim 11, wherein the reader is configured to identify a transmitted validation code by a predetermined silent period before and/or after the response.

13. The reader of claim 11, wherein the validation code comprises a predetermined number of bits.

14. The reader of claim 11, further comprising a memory to store the reference quality, characteristic, and/or property, the memory configured to store a list of validation codes from one or more wireless devices.

15. The reader of claim 14, wherein the controller is adapted to reset the list of validation codes after a predetermined period of time or after power is suspended to the wireless devices.

16. The reader of claim 11, wherein the wireless communication module is configured to demodulate a plurality of successive responses from a wireless device, and the validation circuit is further configured to compare each of the plurality of successive responses to one another, and validate the validation code from the wireless device when the successive responses match one another.

17. The reader of claim 16, wherein the reader is configured to identify a response by a predetermined silent period before and/or after the response.

18. A device, comprising:
a) an antenna configured to receive a wireless signal from a reader and re-radiate, broadcast, or backscatter a response signal, the response signal comprising a validation code having a predetermined quality, characteristic, and/or property;
b) a wireless communication circuit coupled to the antenna, the wireless communication circuit configured to demodulate or otherwise process the wireless signal and modulate an absorption of the wireless signal to provide the response signal; and
c) a response circuit comprising (1) a memory including a validation code storage area, and (2) a response generator configured to transmit the validation code.

19. The device of claim 18, wherein the device comprises a battery, and is configured to initiate the wireless communication with the reader.

20. The device of claim 18, wherein the wireless communication circuit comprises an input and/or output control portion connected to the antenna and the response circuit.

21. The device of claim 18, wherein the wireless communication circuit comprises (i) a demodulator configured to demodulate a command and/or data received from the reader and (ii) a data modulator configured to modulate a signal comprising the validation code to the antenna.

22. The device of claim 21, wherein the wireless communication circuit comprises a clock extractor, the clock extractor configured to produce a clock signal for logic in the response circuit.

23. The device of claim 22, wherein the logic comprises at least one cyclic shift register configured to communicate with the memory and an optional delay/reset circuit.

24. The device of claim 21, wherein the wireless communication circuit comprises a rectifier configured to (i) receive a signal received by the antenna and (ii) provide upper and lower power supplies therefrom.

25. The device of claim 18, wherein the response generator is configured to transmit one of the validation codes a plurality of times, with a predetermined silent period before and/or after each validation code transmission.

26. The device of claim 25, wherein a duration of the predetermined silent period before the validation code transmission differs from a duration of the predetermined silent period after the validation code transmission.
